(19) United States
(12) Patent Application Publication
(10) Pub. No.: US 2011/0143672 A1
(43) Pub. Date: Jun. 16, 2011

(54) METHOD AND SYSTEMS FOR PARALLEL CHANNEL ESTIMATION AND INTERFERENCE CANCELLATION

(75) Inventors: Taesang Yoo, San Diego, CA (US); Tao Luo, San Diego, CA (US); Yongbin Wei, San Diego, CA (US); Hanfang Pan, San Diego, CA (US); Michael A. Howard, San Diego, CA (US)

(73) Assignee: QUALCOMM INCORPORATED, San Diego, CA (US)

(21) Appl. No.: 12/966,185

(22) Filed: Dec. 13, 2010

Related U.S. Application Data
(60) Provisional application No. 61/286,309, filed on Dec. 14, 2009.

(51) Int. Cl. H04B 15/00

(52) U.S. Cl. 455/63.1

(57) ABSTRACT

Certain aspects of the disclosure propose parallel channel estimation and interference cancellation in a wireless communications system. For each common reference signal tone offset, interference cancellation and channel estimation may be performed independently. The proposed channel estimation method may increase performance of a system.

### CLAIM OF PRIORITY UNDER 35 U.S.C. §119

This application claims priority to U.S. Provisional Application No. 61/286,309, entitled “Parallel Channel Estimation for Interference Cancellation in LTE-A,” filed Dec. 14, 2009, and assigned to the assignee hereof and hereby expressly incorporated by reference herein.

### BACKGROUND

1. Technical Field

This disclosure relates generally to communication, and more specifically to providing parallel channel estimation and interference cancellation for wireless communication.

2. Background

The third Generation Partnership Project (3GPP) Long Term Evolution (LTE) represents a major advance in cellular technology and is the next step forward in cellular 3G services as a natural evolution of Global System for Mobile Communications (GSM) and Universal Mobile Telecommunications System (UMTS). The LTE provides for an uplink speed of up to 50 megabits per second (Mbps) and a downlink speed of up to 100 Mbps and brings many technical benefits to cellular networks. The LTE is designed to meet carrier needs for high-speed data and media transport as well as high-capacity voice support. Bandwidth is scalable from 1.25 MHz to 20 MHz. This suits the needs of different network operators that have different bandwidth allocations, and also allows operators to provide different services based on spectrum. The LTE is also expected to improve spectral efficiency in 3G networks, allowing carriers to provide more data and voice services over a given bandwidth. The LTE encompasses high-speed data, multimedia unicast and multimedia broadcast services.

Physical layer (PHY) of the LTE standard is a highly efficient means of conveying both data and control information between an enhanced base station (eNodeB) and mobile user equipment (UE). The LTE PHY employs advanced technologies that are new to cellular applications. These include Orthogonal Frequency Division Multiplexing (OFDM) and Multiple Input Multiple Output (MIMO) data transmission. In addition, the LTE PHY uses Orthogonal Frequency Division Multiple Access (OFDMA) on the downlink (DL) and Single Carrier—Frequency Division Multiple Access (SC-FDMA) on the uplink (UL). OFDMA allows data to be directed to or from multiple users on a subcarrier-by-subcarrier basis for a specified number of symbol periods.

The LTE-Advanced is an evolving mobile communication standard for providing 4G services. Among other things, LTE-Advanced, also called International Mobile Telecommunications-Advanced (IMT-Advanced), meet the requirements for 4G (as defined by the International Telecommunication Union) such as peak data rates up to 1 Gbit/s. Besides the peak data rate, the LTE-Advanced also targets faster switching between power states and improved performance at the cell edge.

### SUMMARY

Certain aspects of the disclosure provide a method for wireless communications. The method generally includes receiving a signal comprising a plurality of reference signals from one or more access points, and cancelling a reference signal of the plurality of reference signals from the signal while simultaneously cancelling a disparate reference signal of the plurality of reference signals that utilizes a separate set of resource elements of the signal.

Certain aspects of the disclosure provide an apparatus for wireless communications. The apparatus generally includes logic for receiving a signal comprising a plurality of reference signals from one or more access points, and logic for cancelling a reference signal of the plurality of reference signals from the signal while simultaneously cancelling a disparate reference signal of the plurality of reference signals that utilizes a separate set of resource elements of the signal.

Certain aspects of the disclosure provide an apparatus for wireless communications. The apparatus generally includes means for receiving a signal comprising a plurality of reference signals from one or more access points, and means for cancelling a reference signal of the plurality of reference signals from the signal while simultaneously cancelling a disparate reference signal of the plurality of reference signals that utilizes a separate set of resource elements of the signal.

Certain aspects provide a computer-program product for wireless communications, comprising a computer-readable medium having instructions stored thereon, the instructions being executable by one or more processors. The instructions generally include instructions for receiving a signal comprising a plurality of reference signals from one or more access points, and instructions for cancelling a reference signal of the plurality of reference signals from the signal while simultaneously cancelling a disparate reference signal of the plurality of reference signals that utilizes a separate set of resource elements of the signal.

Certain aspects of the disclosure provide an apparatus for wireless communications. The apparatus generally includes at least one processor configured to receive a signal comprising a plurality of reference signals from one or more access points, and cancel a reference signal of the plurality of reference signals from the signal while simultaneously cancelling a disparate reference signal of the plurality of reference signals that utilizes a separate set of resource elements of the signal, and a memory coupled to the at least one processor.

### BRIEF DESCRIPTION OF THE DRAWINGS

FIG. 1 illustrates a multiple access wireless communication system, in accordance with certain aspects of the disclosure.

FIG. 2 illustrates a block diagram of multiple input multiple output (MIMO) communication system, in accordance with certain aspects of the disclosure.

FIG. 3 illustrates a system for channel estimation and interference cancellation, in accordance with certain aspects of the disclosure.

FIGS. 4A and 4B illustrate example order of devices for a conventional and a parallel interference cancellation technique, in accordance with certain aspects of the disclosure.

FIG. 5 illustrates a system that provides parallel channel estimation and interference cancellation, in accordance with certain aspects of the disclosure.

FIG. 6 illustrates example operations for parallel channel estimation and interference cancellation, in accordance with certain aspects of the disclosure.

FIG. 6A illustrates example components capable of performing the operations illustrated in FIG. 6.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal A terminal can also be called a system, device, subscriber unit, subscriber station, mobile station, mobile, mobile device, remote station, remote terminal, access terminal, user terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA 2000, etc. UTRA includes Wideband-CDMA (W-CDMA). CDMA2000 covers IS-2000, IS-95 and IS-856 standards. A TDMA network may implement a radio technology such as Global System for Mobile Communications (GSM).

An OFDMA network may implement a radio technology such as Evolved UTRA (E-UTRA), The Institute of Electrical and Electronics Engineers (IEEE) 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below. It should be noted that the LTE terminology is used by way of illustration and the scope of the disclosure is not limited to LTE.

Single carrier frequency division multiple access (SC-FDMA), which utilizes single carrier modulation and frequency domain equalization has similar performance and essentially the same overall complexity as those of an OFDMA system. SC-FDMA signal may have lower peak-to-average power ratio (PAPR) because of its inherent single carrier structure. SC-FDMA may be used in the uplink communications where lower PAPR greatly benefits the mobile terminal in terms of transmit power efficiency.

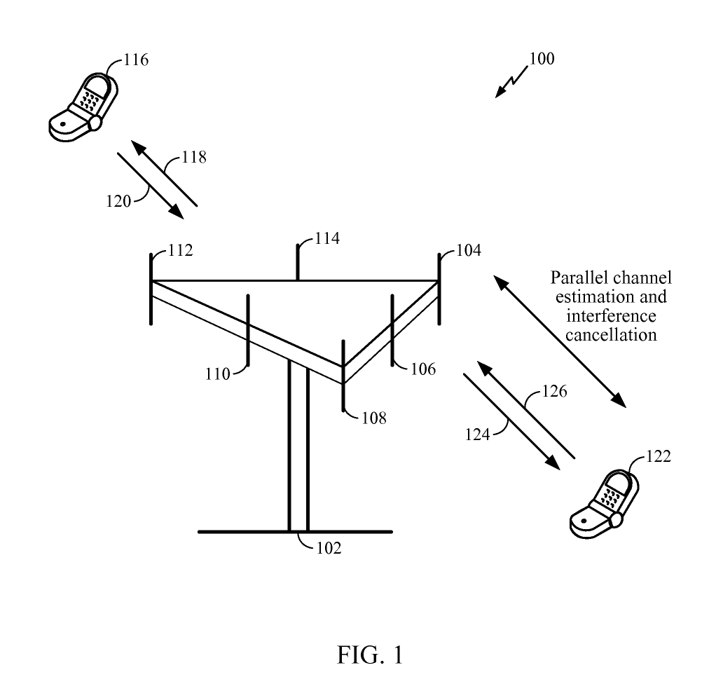

Referring to FIG. 1, a multiple access wireless communication system 100 according to one aspect is illustrated. An access point 102 (AP) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 on downlink 118 and receive information from access terminal 116 on uplink 120. Access terminal 122 is in communication with antennas 104 and 106, where antennas 104 and 106 transmit information to access terminal 122 on downlink 124 and receive information from access terminal 122 on uplink 126. In a Frequency Division Duplex (FDD) system, communication links 118, 120, 124 and 126 may use a different frequency for communication. For example, downlink 118 may use a different frequency than that used by uplink 120.

Each group of antennas and/or the area in which they are designed to communicate is often referred to as a sector of the access point. In an aspect, antenna groups each are designed to communicate to access terminals in a sector of the areas covered by access point 102.

In communication on downlinks 118 and 124, the transmitting antennas of access point 102 utilize beamforming in order to improve the signal-to-noise ratio (SNR) of downlinks for the different access terminals 116 and 122. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as a Node B, an evolved Node B (eNB), or some other terminology. An access terminal may also be called a mobile station, user equipment (UE), a wireless communication device, terminal, or some other terminology. For certain aspects, either the AP 102 or the access terminals 116, 122 may utilize proposed parallel channel estimation and interference cancellation technique to determine characteristics of communication channels.

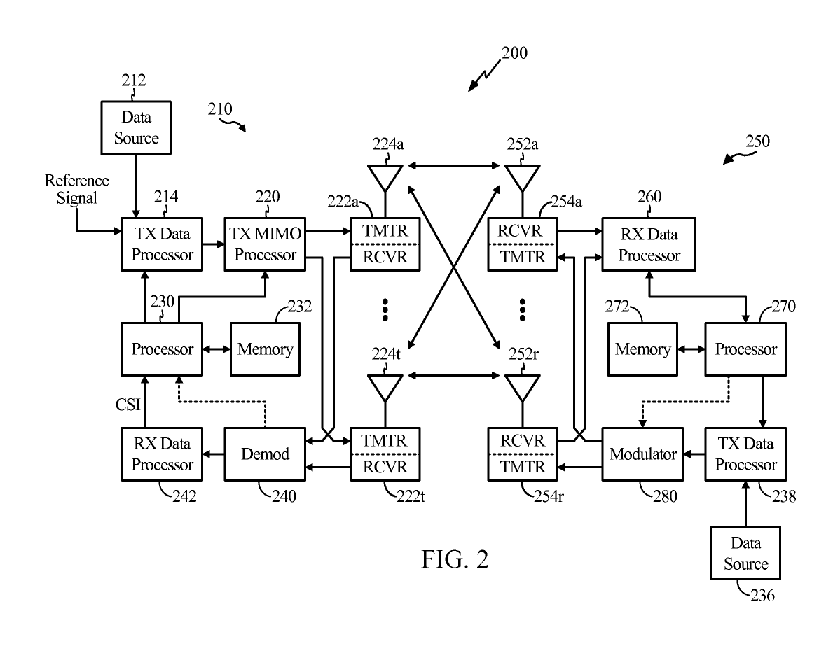

FIG. 2 is a block diagram of an aspect of a transmitter system 210 and a receiver system 250 in a MIMO system 200. At the transmitter system 210, traffic data for a number of data streams is provided from a data source 212 to a transmit (TX) data processor 214.

In an aspect, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., Binary Phase Shift Keying (BPSK), Quadrature Phase Shift Keying (QPSK), M-PSK in which M may be a power of two, or M-QAM (Quadrature Amplitude Modulation)) selected for that data stream to provide modulation symbols. The data rate, coding and modulation for each data stream may be determined by instructions performed by processor 230 that may be coupled with a memory 232.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

A RX data processor 260 then receives and processes the N_{R} received symbol streams from N_{R} receivers 254 based on a particular receiver processing technique to provide N_{T} “detected” symbol streams. The RX data processor 260 then demodulates, deinterleaves and decodes each detected symbol stream to recover the traffic data for the data stream. The processing by RX data processor 260 is complementary to that performed by TX MIMO processor 220 and TX data processor 214 at transmitter system 210. As described in further detail below, the RX data processor 260 may utilize parallel channel estimation and interference cancellation to estimate the channel between the transmitter system and the receiver system and cancel the interference from other transmitting devices.

Processor 270, coupled to a memory 272, formulates a reverse or uplink message. The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240 and processed by a RX data processor 242 to extract the reserve or uplink message transmitted by the receiver system 250.

Certain aspects of the disclosure propose parallel channel estimation and interference cancellation in a wireless communications system. For each common reference signal (CRS) tone offset, interference cancellation and channel estimation may be performed independently. The proposed channel estimation method may increase performance of a system.

In a heterogeneous network, a UE may improve its performance by utilizing Interference Cancellation (IC) to eliminate interference caused by transmissions from other devices (e.g., other UEs and/or access points). Interference cancellation may enable deep penetration of broadcast signals such as primary synchronization signal (PSS), secondary synchronization signal (SSS), physical broadcast channel (PBCH), and common reference signals (CRS). Interference cancellation may enhance UE experience by eliminating coverage holes created by strong interferers. Common reference signals may be present over the entire system bandwidth and on every subframe. Therefore, an interference cancellation (IC) technique that utilizes common reference signals (CRSs) may enhance decoding and measurement performance of a UE.

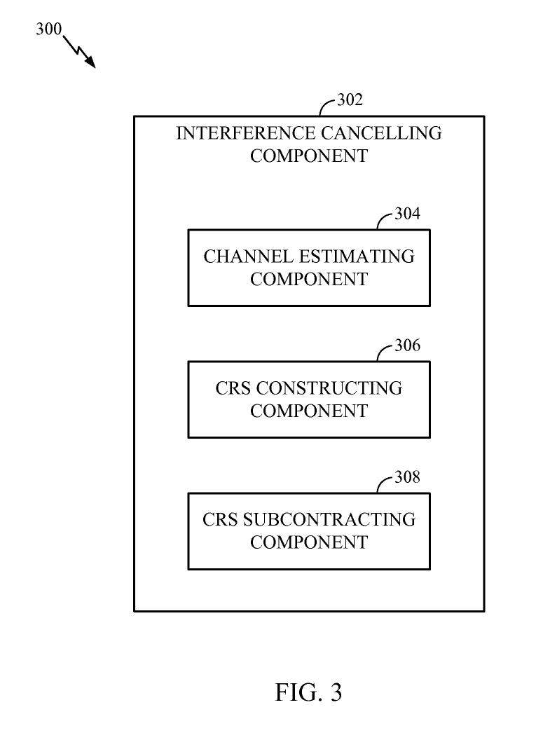

FIG. 3 illustrates a system 300 that cancels interference from received signals and estimates one or more channels based on the received signals. System 300 includes an interference cancelling component 302 that may reside inside a wireless device such as a UE. The interference cancelling component 302 receives one or more signals (e.g., from a plurality of access points, which may be heterogeneously deployed in one example), cancels interference from the received signals and determines one or more disparate CRSs in the one or more received signals. The CRSs may be used to estimate a channel between the UE and each of the plurality of transmitting devices (e.g., access points). Given a signal, for example, CRSs may be cancelled sequentially or iteratively to facilitate interpreting multiple CRSs in the signal free from interference from stronger CRSs in the signal. Interference cancelling component 302 may include a channel estimating component 304 that may perform channel estimation on a received signal. The channel estimating component may estimate a channel between the UE and one of the access points. Each of the access points may be identified with an identifier (ID). The Interference cancelling component 302 may also include a CRS constructing component 306 that reconstructs the CRS of each access point based on the channel estimation, and a CRS subtracting component 308 that cancels the CRS from the received signal to generate an updated received signal. The updated received signal may then be used to estimate another channel between a disparate access point and the UE.

It should be noted that although the disclosure focuses on CRS IC, the ideas and techniques described herein may be applied to other channels, for example, UE-specific RS, channel state information (CSI)-RS, and the like, all of which fall into the scope of the disclosure.

According to an example, interference cancelling component 302 can be implemented within a mobile device, access point, and/or substantially any device that interprets CRSs in a wireless network. Interference cancelling component 302 may receive a signal from one or more surrounding devices. Channel estimating component 304 can estimate channels of the interfering devices utilizing the received signal. Each of the surrounding devices may be associated with an identifier. CRS constructing component 306 can re-create the CRSs of the interfering device based on the estimated channel. CRS subtracting component 308 may remove the CRS from the received signal. Additional CRSs may be constructed and removed from the remaining signal to facilitate channel estimation utilizing the signal substantially free from interference of stronger CRSs. Also, the CRSs may facilitate decoding control channels such as Physical Control Format Indicator Channel (PCFICH), Physical Hybrid Automatic Repeat Request Indicator Channel (PHICH), and Physical Downlink Control Channel (PDCCH), and data channels such as Physical Downlink Shared Channel (PDSCH) utilizing the control and data signals that are free from interference of stronger CRSs.

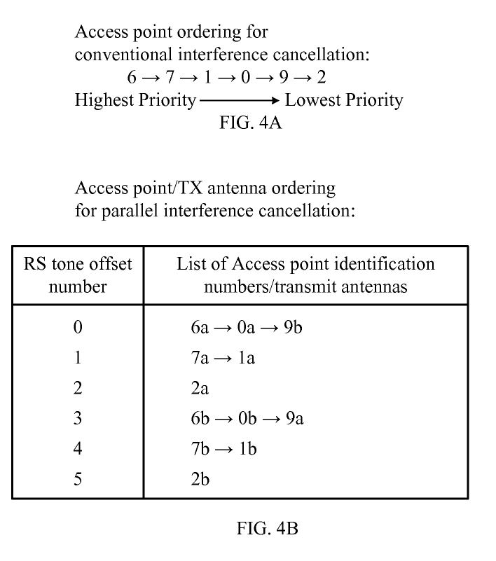

In conventional IC algorithms, cells may be ordered (e.g., in decreasing order of signal strengths), and interference caused by interfering devices may be cancelled one by one either sequentially or iteratively. For example, a UE may receive signals from a plurality of access points (e.g., access points with cell identifiers (Cell IDs) equal to 0, 1, 2, 6, 7 and 9). The access points may be ordered in decreasing signal strength (e.g., 6→7→1→0→9→2 as illustrated in FIG. 4A). Using an interference cancellation technique, the UE may estimate channel from the cell with the strongest received signal (e.g., cell ID 6), reconstruct the common reference signal of the cell ID 6, and subtract the reconstructed signal from the received signal to cancel the interference caused by the cell ID 6. The process may be repeated on the received signal to cancel the interference from the other cells (e.g., cells with IDs: 7, 1, 0, 9, and 2).

Traditionally, an interference cancellation algorithm may be performed by a single piece of hardware (or digital signal processor (DSP) or the like) that cancels the interference from different cells sequentially over time. Similarly, an iterative interference cancellation technique may also use a single piece of hardware over time. For example, in the above example, if two iterations are performed between cell IDs 7 and 1, the IC algorithm may be performed in the following order: 6→7→1→7→1→0→9→2. Therefore, the same piece of hardware may run eight times to cancel interference from all of the access points (e.g., cells).

Maximum number of interfering signals that a device is able to cancel (e.g., CRS IC capability) may be dictated by the timeline by which the interference cancellation should be completed. For example, if T_{IC} represents the time allowed for interference cancellation and t_{IC} represents the time spent on cancelling interference from each interfering cell, maximum number of cells whose interference can be cancelled (N_{IC}) may be defined as follows: N_{IC}≦T_{IC}/t_{IC}.

Certain aspects of the disclosure propose a parallel interference cancellation technique that may increase the CRS IC capability by cancelling interference from a plurality of cells in parallel.

In a communication system, CRS tone positions may have a regular structure. For example, CRS tones of cell ID m for its first and second transmit antennas (t={0,1}) may occupy a specific set of resource elements S(n), n=0,1,2,3,4,5, in which n represents an CRS tone offset and n=(m+3 t) mod 6. The operator mod in the above equation represents a modulus operator.

In addition, CRS tones of cell ID m and transmit antenna index t={2,3} may occupy another set of resource elements T(n), n=0,1,2,3,4,5, n=(m+3 t) mod 6. The sets S(n), n=0,1,2,3,4,5 may be disjoint, (e.g., S(n1) ∩ S(n2)=ø if n1≠n2). The sets T(n), n=0,1,2,3,4,5 may also be disjoint, (e.g., T(n1) ∩ T(n2)=ø if n1≠n2). Therefore, CRS IC among cells and transmit antenna indices of different CRS tone offsets may be performed independently.

For certain aspects of the disclosure, while performing CRS IC, separate lists may be maintained for each CRS tone offset as illustrated in the example in FIGS. 4A and 4B. FIG. 4A illustrates an example order of devices (e.g., cells or access points) for a conventional interference cancellation technique. As illustrated, the devices may be ordered from highest priority to lowest priority. Priority of the devices may be determined based on quality of the received signal.

FIG. 4B illustrates an example order of devices for parallel interference cancellation, in accordance with certain aspects of the disclosure. For each CRS tone offset, a list of access point ID numbers (e.g., Cell IDs) and transmit antenna identifications may be generated. The list may also be ordered based on SNR of the signals received from each access point. For example, for n=0, interference from cells 6a, 0a and 9b may be cancelled, in which numbers indicate cell IDs, and alphabets a and b indicate transmit antenna indices 0 and 1, respectively. As illustrated, for n=0, . . . , 5, six different lists of interferers may be generated, that may be used in six parallel interference cancellation components.

For certain aspects, parallel hardware components, digital signal processors (DSPs) or similar architectures may be used for performing interference cancellation on a plurality of CRS tone offsets in parallel. As an example, in the system in FIG. 4B, six parallel hardware blocks may be used, each of which may cancel interference associated with a CRS tone offset. This approach may reduce the IC timeline by a factor of six and increase CRS IC capability.

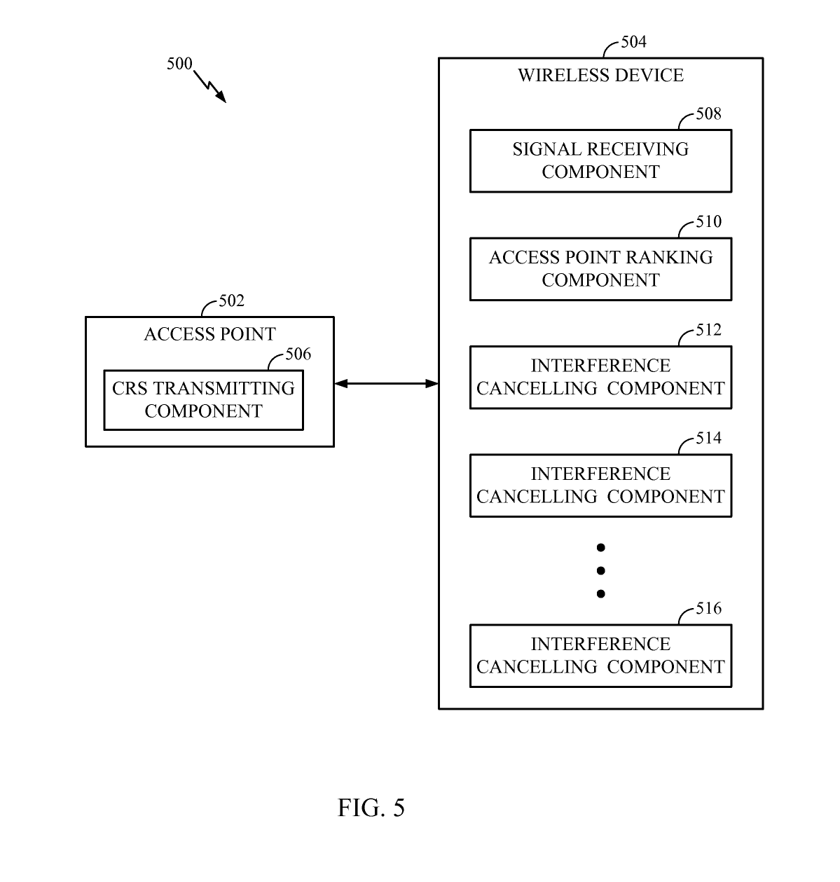

FIG. 5 illustrates a system 500 that utilizes parallel channel estimation and interference cancellation, in accordance with certain aspects of the disclosure. System 500 may include an access point 502 that communicates with one or more wireless devices, such as wireless device 504, to provide wireless network access thereto. Access point 502 can be a macrocell access point, femtocell access point, picocell access point, relay node, mobile base station, and/or substantially any device that provides access to a wireless network. Wireless device 504 can be any kind of mobile device that receives access to a wireless network. The wireless device 504 can be a mobile station, user equipment, relay node, a tethered device, such as a modem, and/or the like.

Access point 502 may include a CRS transmitting component 506 that transmits CRSs in a wireless network. Wireless device 504 may include a signal receiving component 508 that obtains one or more CRSs from one or more access points (only one access point is shown) in a wireless network. The wireless device may also include an access point ranking component 510 that orders the one or more access points according to communication metrics, such as signal strength, SNR, etc. The wireless device may also include a plurality of interference cancelling components 512, 514, and 516 that can remove interference from received signals and perform channel estimation.

It should be noted that each of the interference cancelling components 512, 514 and 516 may be similar to the interference cancelling component 302. The interference cancelling components 512, 514, and 516 can operate synchronously to remove interference from the received signals and perform channel estimation (e.g., on independent processors (hardware or software), DSPs, and/or the like). In addition, it is to be appreciated that any number of interference cancelling components may be present in a device.

According to an example, CRS transmitting component 506 may transmit a CRS. Though not depicted, other access points can similarly transmit disparate CRSs (e.g., using similar CRS transmitting components). In heterogeneously deployed networks, however, signals from multiple access points can be received at various strengths in a single signal at the wireless device 504. Thus, one or more CRSs are interfered by other CRSs in the received signal. Signal receiving component 508 can receive the CRSs from CRS transmitting component 506 and/or additional access points in a single received signal.

In addition, access point ranking component 510 can determine a ranking for access point 502, the additional access points, and/or related cells, according to their signal strength, signal-to-noise ratio (SNR), or similar communication metric of the access points. In one example, access point ranking component can order the access points or related cells according to highest SNR.

Interference cancelling components 512, 514, and 516 can simultaneously separate CRSs from the received signals and cancel the CRSs to facilitate processing of other CRSs in the received signal, as described above. As described, interference cancelling components 512, 514, and 516 can perform channel estimation over a received signal for the access point 502.

For certain aspects, interference cancelling components 512, 514, and 516 may apply different channel estimation algorithms for different antennas of the access point 502 or additional access points. Moreover, for example, the ranking may be determined based on the quality of signals at each antenna. For example, order of the devices shown in FIG. 4A may be depicted as follows to illustrate order of different transmit antennas of each cell: 6a→7b→6b→1b→1a7a→0b→9a→9b→2a→0a→2b. Further, for certain aspects, interference cancelling components 512, 514, and 516 may perform interference estimation and calibration per antenna.

As described above, CRS IC for the access point 502, additional access points, or related cells over the transmit antenna indices having different CRS tone offsets (n) may each be performed independently using a given received signal. CRS IC for each CRS tone offset may utilize a disparate interference cancelling component 512, 514, or 516 (or related processor, hardware, software, DSP, etc.). CRS IC can thus be performed in parallel for the disparate CRSs having disparate CRS tone offsets in the received signal. For example, six separate interference cancelling components (e.g., and related processors) may be utilized to perform CRS IC on the six offsets shown in FIG. 4B.

For certain aspects, interference cancellation may be performed on two or more CRS tone offsets sequentially. For example, instead of performing a separate interference cancellation for each CRS tone offset in FIG. 4B, a simplified but suboptimal alternative may be to have three separate lists for three parallel interference cancellation components. The three parallel interference cancelling components can be utilized to perform CRS IC (e.g., one for offsets 0 and 3, one for offsets 1 and 4, and one for offsets 2 and 5), and so on. Another variation may be to have two separate lists for two parallel interference cancelling components. For example, one interference cancelling component may be utilized to perform CRS IC on CRS tone offsets 0, 1, and 2. The second parallel interference cancelling component may be utilized to perform CRS IC on CRS tone offsets 3, 4, and 5.

In another example, access point ranking component 510 can optimize ordering per transmit antenna, such that ordering (e.g., based on signal strength, SNR, etc.) is performed for each antenna (or a set of antennas) of access point 502, additional access points, or cells thereof. Moreover, for example, interference cancelling components 512, 514, and 516 can calculate a minimum mean square error (MMSE) weighing factor for soft canceling the CRSs from the received signal per antenna or set of antennas.

Channel estimation for different receive antennas of a wireless device may be disjoint. Therefore, for certain aspects, a plurality of parallel hardware blocks may be used for each receive antenna. For example, the number of parallel hardware blocks or DSPs in a device may be less than or equal to the number of CRS tone offsets (n) times the number of receive antennas (N_{R}).

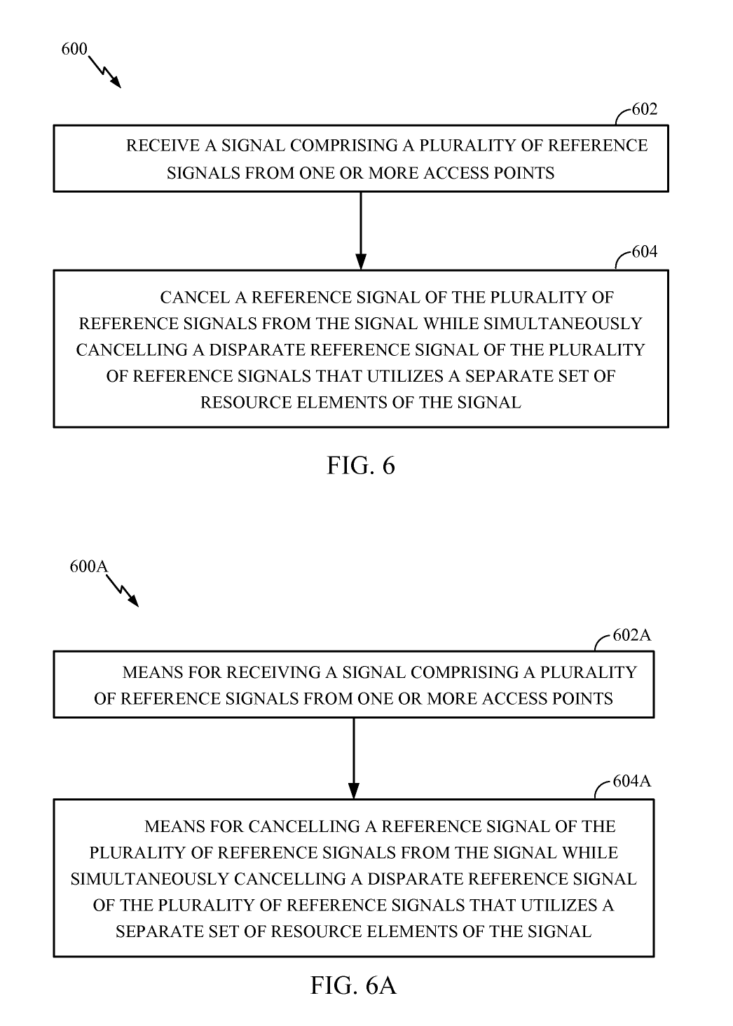

FIG. 6 illustrates example operations 600 for parallel channel estimation and interference cancellation, in accordance with certain aspects of the disclosure. At 602, a signal comprising a plurality of reference signals may be received from one or more access points. For example, in heterogeneously deployed networks, a plurality of common reference signals (CRSs) from various access points can be received having various SNRs or signal strengths. At 604, a reference signal of the plurality of reference signals may be cancelled from the signal. In this regard, other RSs may be derived without interference from the cancelled RS. A disparate reference signal of the plurality of reference signals (e.g., CRSs) occupying a disparate set of resource elements of the signal may be simultaneously cancelled.

A reference signal may be cancelled by performing channel estimation over the signal, generating the reference signal from the estimated channel, and removing the reference signal from the signal. Communication channels from the one or more access points may also be estimated in parallel. Thus, CRS IC can be performed in parallel over a plurality of CRSs received in the signal on CRSs occupying disparate sets of resource elements, as described. In addition, the access point may receive a disparate signal over a disparate antenna, and simultaneously cancel a different reference signal from the disparate signal.

The various operations of methods described above may be performed by any suitable means capable of performing the corresponding functions. The means may include various hardware and/or software component(s) and/or module(s), including, but not limited to a circuit, an application specific integrate circuit (ASIC), or processor. Generally, where there are operations illustrated in figures, those operations may have corresponding counterpart means-plus-function components with similar numbering.

For example, operations 600 illustrated in FIG. 6 correspond to means plus function blocks 600A illustrated in FIG. 6A. The means for receiving a signal comprises a receiver. The means for cancelling a CRS may comprise any suitable type of cancelling component, such as the interference cancelling component 512 illustrated in FIG. 5. These components may be implemented with any suitable components, such as one or more processors, for example, such as the RX data processor 260 and/or processor 270 of the receiver system 250 illustrated in FIG. 2.

The various illustrative logical blocks, modules and circuits described in connection with the disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the disclosure, other and further aspects of the disclosure may be devised without departing from the basic scope thereof, and the scope thereof is determined by the claims that follow.

What is claimed is:

1. A method for wireless communications, comprising:
receiving a signal comprising a plurality of reference signals from one or more access points; and
cancelling a reference signal of the plurality of reference signals from the signal while simultaneously cancelling a disparate reference signal of the plurality of reference signals that utilizes a separate set of resource elements of the signal.

2. The method of claim 1, wherein cancelling the reference signal comprises performing channel estimation over the signal, generating the reference signal from the estimated channel, and removing the reference signal from the signal.

3. The method of claim 1, wherein the reference signal and the disparate reference signal are transmitted from disparate antennas of one of the one or more access points.

4. The method of claim 1, further comprising:
ordering the one or more access points according to signal-to-noise ratio of the one or more access points.

5. The method of claim 1, further comprising:
ordering one or more transmit antennas of the one or more access points according to signal-to-noise ratio of the one or more transmit antennas of the one or more access points.

6. The method of claim 1, further comprising receiving a disparate signal over a disparate antenna, and simultaneously cancelling a different reference signal from the disparate signal.

7. The method of claim 1, wherein the plurality of reference signals comprise a plurality of common reference signals (CRSs).

8. An apparatus for wireless communications, comprising:
logic for receiving a signal comprising a plurality of reference signals from one or more access points; and
logic for cancelling a reference signal of the plurality of reference signals from the signal while simultaneously cancelling a disparate reference signal of the plurality of reference signals that utilizes a separate set of resource elements of the signal.

9. The apparatus of claim 8, wherein the logic for cancelling the reference signal comprises logic for performing channel estimation over the signal, logic for generating the reference signal from the estimated channel, and logic for removing the reference signal from the signal.

10. The apparatus of claim 8, wherein the reference signal and the disparate reference signal are transmitted from disparate antennas of one of the one or more access points.

11. The apparatus of claim 8, further comprising:
logic for ordering the one or more access points according to signal-to-noise ratio of the one or more access points.

12. The apparatus of claim 8, further comprising:
logic for ordering one or more transmit antennas of the one or more access points according to signal-to-noise ratio of the one or more transmit antennas of the one or more access points.

13. The apparatus of claim 8, further comprising logic for receiving a disparate signal over a disparate antenna, and simultaneously cancelling a different reference signal from the disparate signal.

14. The apparatus of claim 8, wherein the plurality of reference signals comprise a plurality of common reference signals (CRSs).

15. An apparatus for wireless communications, comprising:
means for receiving a signal comprising a plurality of reference signals from one or more access points; and
means for cancelling a reference signal of the plurality of reference signals from the signal while simultaneously cancelling a disparate reference signal of the plurality of reference signals that utilizes a separate set of resource elements of the signal.

16. The apparatus of claim 15, wherein the means for cancelling the reference signal comprises means for performing channel estimation over the signal, means for generating the reference signal from the estimated channel, and means for removing the reference signal from the signal.

17. The apparatus of claim 15, wherein the reference signal and the disparate reference signal are transmitted from disparate antennas of one of the one or more access points.

18. The apparatus of claim 15, further comprising:
means for ordering the one or more access points according to signal-to-noise ratio of the one or more access points.

19. The apparatus of claim 15, further comprising:
means for ordering one or more transmit antennas of the one or more access points according to signal-to-noise ratio of the one or more transmit antennas of the one or more access points.

20. The apparatus of claim 15, further comprising means for receiving a disparate signal over a disparate antenna, and simultaneously cancelling a different reference signal from the disparate signal.

21. The apparatus of claim 15, wherein the plurality of reference signals comprise a plurality of common reference signals (CRSs).

22. A computer-program product for wireless communications, comprising a computer readable medium having instructions stored thereon, the instructions being executable by one or more processors and the instructions comprising:
instructions for receiving a signal comprising a plurality of reference signals from one or more access points; and
instructions for cancelling a reference signal of the plurality of reference signals from the signal while simultaneously cancelling a disparate reference signal of the plurality of reference signals that utilizes a separate set of resource elements of the signal.

23. An apparatus for wireless communications, comprising at least one processor configured to:
receive a signal comprising a plurality of reference signals from one or more access points; and
cancel a reference signal of the plurality of reference signals from the signal while simultaneously cancelling a disparate reference signal of the plurality of reference signals that utilizes a separate set of resource elements of the signal; and
a memory coupled to the at least one processor.
